(19) United States
(12) Patent Application Publication
(10) Pub. No.: US 2015/0188421 A1
(43) Pub. Date: Jul. 2, 2015

(54) VOLTAGE REGULATOR

(71) Applicant: SAMSUNG ELECTRO-MECHANICS CO., LTD., Suwon-Si (KR)

(72) Inventor: Joo Yul KO, Suwon-Si (KR)

(73) Assignee: SAMSUNG ELECTRO-MECHANICS CO., LTD., Suwon-Si (KR)

(21) Appl. No.: 14/249,103

(22) Filed: Apr. 9, 2014

(30) Foreign Application Priority Data
Dec. 26, 2013 (KR) 10-2013-0164124

(51) Int. Cl. H02M 3/156; H02M 1/32

(52) U.S. Cl. CPC H02M 3/156; H02M 1/32; H02M 2001/0003

(57) ABSTRACT

A voltage regulator may includes: a voltage regulator circuit unit converting an input voltage into an output voltage; a voltage monitoring unit detecting the level of the input voltage or the output voltage of the voltage regulator circuit unit, comparing the levels of the detected voltage and a set voltage with each other, and controlling a bypass path depending on the comparison result; and a bypass circuit unit forming the bypass path between an input terminal and an output terminal of the voltage regulator circuit unit depending on the control of the bypass path by the voltage monitoring unit.

### CROSS-REFERENCE TO RELATED APPLICATION

This application claims the benefit of Korean Patent Application No. 10-2013-0164124 filed on Dec. 26, 2013, with the Korean Intellectual Property Office, the disclosure of which is incorporated herein by reference.

### BACKGROUND

The prevent disclosure relates to a voltage regulator.

Generally, research into a power amplifier to which a complementary metal oxide semiconductor (CMOS) technology appropriate for thinness, lightness and integration in products is applied has been actively conducted.

In addition, a voltage regulator may be used in the power amplifier in order to stably control an operation of the power amplifier. Alternatively, the voltage regulator is required in order to provide a stable operating voltage to a driver integrated circuit (IC) of a motor, but is not limited thereto. That is, the voltage regulator may be used in a system requiring stable voltage.

Among others, a low drop output (LDO) type voltage regulator capable of down-converting a voltage, being simply designed, and decreasing current consumption may be used.

An existing LDO type voltage regulator is generally operated in a region in which an output voltage is fixed to 1.8V in the case in which an external voltage is 1.8V to 5.5V. However, there is a case in which such an LDO type voltage regulator is required to be continuously operated, even in the case that a voltage lower than 1.8V is applied thereto in some applications.

The existing LDO type voltage regulator performs an under voltage lockout (UVLO) operation in which it is turned off when an input voltage drops to the level of a reference voltage or below or performs an operation in which an LDO voltage is lowered while being decreased in a predetermined ratio with respect to the external voltage.

However, since the driver IC of the motor should be continuously operated, even at a predetermined output voltage or below, in the case in which a speed thereof is adjusted through power amplitude modulation (PAM), an operation thereof may become unstable in the case in which an operation thereof is stopped or an operating voltage thereof is lowered.

Therefore, a technology capable of continuously supplying a stable voltage even in a case in which an input voltage drops to the level of a reference voltage or below is required.

### SUMMARY

An aspect of the present disclosure may provide a voltage regulator capable of continuously outputting a voltage using a bypass mode even in the case in which an input voltage or an output voltage drops to the level of a reference voltage or below.

According to an aspect of the present disclosure, a voltage regulator may include: a voltage regulator circuit unit converting an input voltage into an output voltage; a voltage monitoring unit detecting the level of the input voltage or the output voltage of the voltage regulator circuit unit, comparing the levels of the detected voltage and a set voltage with each other, and controlling a bypass path depending on the comparison result; and a bypass circuit unit forming the bypass path between an input terminal and an output terminal of the voltage regulator circuit unit depending on the control of the bypass path by the voltage monitoring unit.

The voltage monitoring unit may include: a voltage detecting unit detecting the level of the input voltage or the output voltage of the voltage regulator circuit unit to provide the detected voltage; and a comparing unit comparing the levels of the detected voltage and the set voltage with each other and providing a control signal to the bypass circuit unit depending on the comparison result.

The bypass circuit unit may include a semiconductor switching device connected between the input terminal and the output terminal of the voltage regulator circuit unit, wherein the semiconductor switching device is operated in a switched-on state depending on the control of the bypass path by the voltage monitoring unit.

According to another aspect of the present disclosure, a voltage regulator may include: a voltage regulator circuit unit converting an input voltage into an output voltage; a voltage monitoring unit detecting the level of the input voltage or the output voltage of the voltage regulator circuit unit, comparing the levels of the detected voltage and a set voltage with each other, controlling a bypass path depending on the comparison result, and disabling the voltage regulator circuit unit; and a bypass circuit unit forming the bypass path between an input terminal and an output terminal of the voltage regulator circuit unit depending on the control of the bypass path by the voltage monitoring unit.

The voltage monitoring unit may include: a voltage detecting unit detecting the level of the input voltage or the output voltage of the voltage regulator circuit unit to provide the detected voltage; and a comparing unit comparing the levels of the detected voltage and the set voltage with each other and providing a control signal to the bypass circuit unit depending on the comparison result.

The bypass circuit unit may include a semiconductor switching device connected between the input terminal and the output terminal of the voltage regulator circuit unit, wherein the semiconductor switching device is operated in a switched-on state depending on the control of the bypass path by the voltage monitoring unit.

According to another aspect of the present disclosure, a voltage regulator may include: a voltage regulator circuit unit providing an output voltage lower than an input voltage; a voltage monitoring unit detecting the level of the input voltage or the output voltage of the voltage regulator circuit unit and controlling a bypass path when the level of the detected voltage is lower than a set voltage; and a bypass circuit unit forming the bypass path between an input terminal and an output terminal of the voltage regulator circuit unit depending on the control of the bypass path by the voltage monitoring unit.

The voltage regulator circuit unit may include: an error amplifying unit providing a gate signal depending on a voltage difference between a reference voltage and a feedback voltage; a semiconductor device adjusting a current between the input terminal receiving the input voltage and a ground depending on the gate signal; and a feedback voltage detecting unit connected between the semiconductor device and the ground to detect the level of the feedback voltage.

The voltage monitoring unit may include: a voltage detecting unit detecting the level of the input voltage or the output voltage of the voltage regulator circuit unit to provide the detected voltage; and a comparing unit comparing the levels of the detected voltage and the set voltage with each other and providing a control signal to the bypass circuit unit depending on the comparison result.

The voltage detecting unit may divide the output voltage using at least one resistor.

The comparing unit may include an operational amplifier having a non-inverting input terminal receiving the set voltage, an inverting input terminal receiving the detected voltage, and an output terminal comparing the levels of the detected voltage and the set voltage with each other and providing the control signal depending on the comparison result.

The comparing unit may include an operational amplifier having a non-inverting input terminal receiving the detected voltage, an inverting input terminal receiving the set voltage, and an output terminal comparing the levels of the detected voltage and the set voltage with each other and providing the control signal depending on the comparison result.

The bypass circuit unit may include a semiconductor switching device connected between the input terminal and the output terminal of the voltage regulator circuit unit, wherein the semiconductor switching device is operated in a switched-on state depending on the control of the bypass path by the voltage monitoring unit.

According to another aspect of the present disclosure, a voltage regulator may include: a voltage regulator circuit unit providing an output voltage lower than an input voltage; a voltage monitoring unit detecting the level of the input voltage or the output voltage of the voltage regulator circuit unit, controlling a bypass path when the level of the detected voltage is lower than a set voltage, and disabling the voltage regulator circuit unit; and a bypass circuit unit forming the bypass path between an input terminal and an output terminal of the voltage regulator circuit unit depending on the control of the bypass path by the voltage monitoring unit.

The voltage regulator circuit unit may include: an error amplifying unit providing a gate signal depending on a voltage difference between a reference voltage and a feedback voltage; a semiconductor device adjusting a current between the input terminal receiving the input voltage and a ground depending on the gate signal; and a feedback voltage detecting unit connected between the semiconductor device and the ground to detect the level of the feedback voltage.

The voltage monitoring unit may include: a voltage detecting unit detecting the level of the input voltage or the output voltage of the voltage regulator circuit unit to provide the detected voltage; and a comparing unit comparing the levels of the detected voltage and the set voltage with each other and providing a control signal to the bypass circuit unit depending on the comparison result.

The voltage detecting unit may include first and second resistors connected in series with each other between the output terminal of the voltage regulator circuit unit and a ground, and the detected voltage may be provided from a connection node between the first and second resistors.

The comparing unit may include an operational amplifier having a non-inverting input terminal receiving the set voltage, an inverting input terminal receiving the detected voltage, and an output terminal comparing the levels of the detected voltage and the set voltage with each other and providing the control signal depending on the comparison result, wherein the operational amplifier provides the control signal to the bypass circuit unit and the voltage regulator circuit unit, respectively.

The comparing unit may include an operational amplifier having a non-inverting input terminal receiving the detected voltage, an inverting input terminal receiving the set voltage, and an output terminal comparing the levels of the detected voltage and the set voltage with each other and providing the control signal depending on the comparison result, wherein the operational amplifier provides the control signal to the bypass circuit unit and the voltage regulator circuit unit, respectively.

The bypass circuit unit may include a semiconductor switching device connected between the input terminal and the output terminal of the voltage regulator circuit unit, wherein the semiconductor switching device is operated in a switched-on state depending on the control of the bypass path by the voltage monitoring unit.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a block diagram of a voltage regulator according to an exemplary embodiment of the present disclosure;

FIG. 2 is a block diagram of a voltage regulator according to another exemplary embodiment of the present disclosure;

FIG. 3 is a block diagram of a voltage regulator according to another exemplary embodiment of the present disclosure;

FIG. 4 is a block diagram of a voltage regulator according to another exemplary embodiment of the present disclosure;

FIG. 5 is a circuit diagram of a voltage regulator circuit unit according to an exemplary embodiment of the present disclosure;

FIG. 6 is a detailed diagram of a voltage monitoring unit and a bypass circuit unit according to an exemplary embodiment of the present disclosure;

FIG. 7 is a diagram showing an implementation of a comparing unit and a bypass circuit unit according to an exemplary embodiment of the present disclosure;

FIG. 8 is a diagram showing another implementation of a comparing unit and a bypass circuit unit according to an exemplary embodiment of the present disclosure;

FIG. 9 is a diagram for describing a voltage supplying path by a regulating mode according to an exemplary embodiment of the present disclosure; and

FIG. 10 is a diagram for describing a voltage supplying path by a bypass mode according to an exemplary embodiment of the present disclosure.

### DETAILED DESCRIPTION

Hereinafter, embodiments of the present disclosure will be described in detail with reference to the accompanying drawings. The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. Throughout the drawings, the same or like reference numerals will be used to designate the same or like elements.

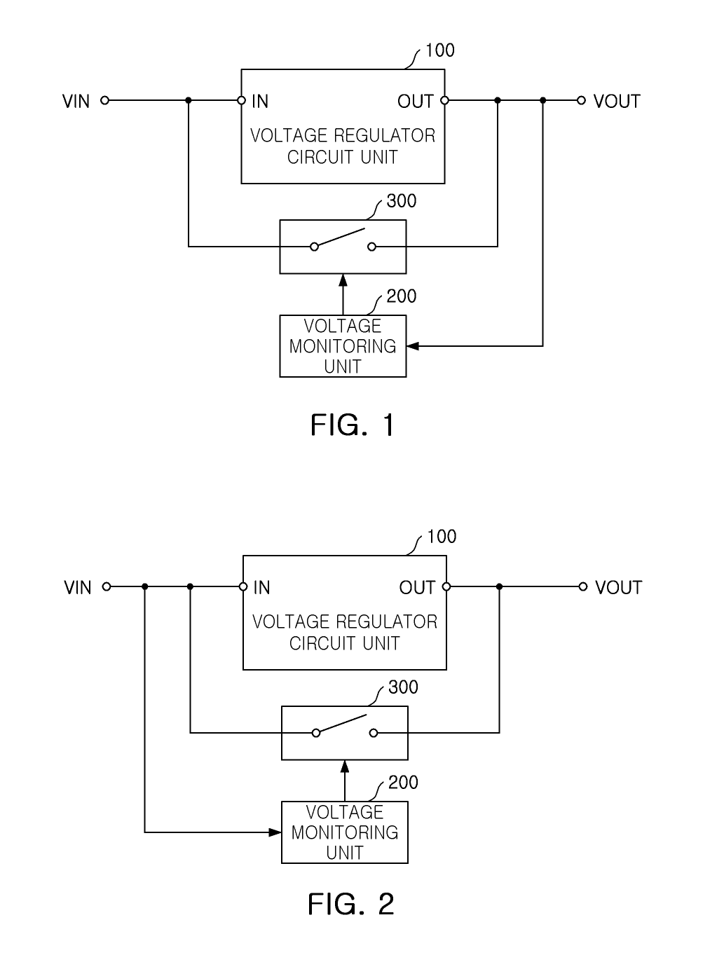

FIG. 1 is a block diagram of a voltage regulator according to an exemplary embodiment of the present disclosure; and FIG. 2 is a block diagram of a voltage regulator according to another exemplary embodiment of the present disclosure.

Referring to FIGS. 1 and 2, a voltage regulator according to exemplary embodiments of the present disclosure may include a voltage regulator circuit unit 100, a voltage monitoring unit 200, and a bypass circuit unit 300.

The voltage regulator circuit unit 100 may convert an input voltage VIN into an output voltage VOUT. Here, even in the state in which the input voltage VIN may be changed and become unstable, the voltage regulator circuit unit 100 may provide a more stable output voltage VOUT in an enable state.

For example, the voltage regulator circuit unit 100 may be a low drop output (LDO) type voltage regulator providing an output voltage having a level lower than an input voltage, but is not limited thereto.

The voltage monitoring unit 200 may detect the level of the input voltage or the output voltage of the voltage regulator circuit unit 100, compare the levels of the detected voltage and a set voltage with each other, and control a bypass path depending on the comparison result.

For example, the voltage monitoring unit 200 may monitor the output voltage of the voltage regulator circuit unit 100, as shown in FIG. 1. Alternatively, the voltage monitoring unit 200 may monitor the input voltage of the voltage regulator circuit unit 100, as shown in FIG. 2.

In addition, the bypass circuit unit 300 may form the bypass path between an input terminal and an output terminal of the voltage regulator circuit unit 100, depending on the control of the bypass path by the voltage monitoring unit 200.

Here, when the bypass path between the input terminal and the output terminal of the voltage regulator circuit unit 100 is formed by the bypass circuit unit 300, the input voltage VIN input to the input terminal IN of the voltage regulator circuit unit 100 may be provided directly to the output terminal OUT of the voltage regulator circuit unit 100 through the bypass circuit unit 300 without passing through the voltage regulator circuit unit 100.

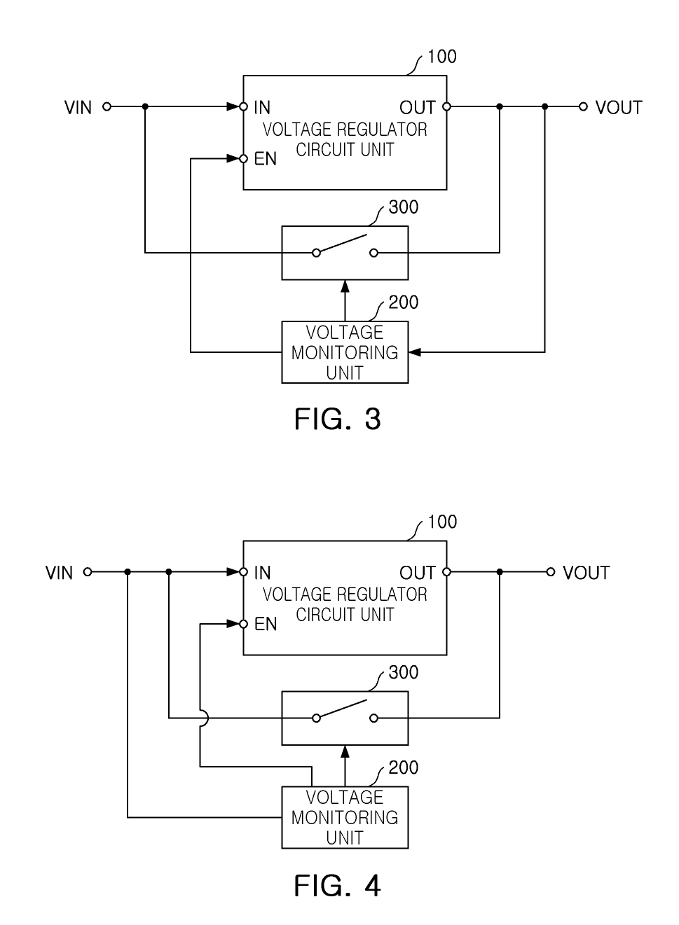

FIG. 3 is a block diagram of a voltage regulator according to another exemplary embodiment of the present disclosure; and FIG. 4 is a block diagram of a voltage regulator according to another exemplary embodiment of the present disclosure.

Referring to FIGS. 3 and 4, a voltage regulator according to exemplary embodiments of the present disclosure may include a voltage regulator circuit unit 100, a voltage monitoring unit 200, and a bypass circuit unit 300.

The voltage regulator circuit unit 100 may provide an output voltage having a level lower than that of an input voltage. Here, even in the case in which the input voltage VIN may be changed, the voltage regulator circuit unit 100 may provide a constant output voltage VOUT regardless of the change in the input voltage, in an enable state.

For example, in the case in which the input voltage VIN is changed within a range of 1.8V to 5.5V, the voltage regulator circuit unit 100 may provide a constant output voltage VOUT of 1.8V. Here, the input voltage VIN and the output voltage VOUT are only examples, and the present disclosure is not limited thereto.

The voltage monitoring unit 200 may detect the input voltage or the output voltage of the voltage regulator circuit unit 100, compare the detected voltage and the set voltage with each other, control a bypass path depending on the comparison result, and disable the voltage regulator circuit unit 100. Here, the voltage regulator circuit unit 100 may include an enable/disable terminal EN and may be operated in an enable state or a disable state depending on a logical (high or low) level of the enable/disable terminal EN.

For example, the voltage monitoring unit 200 may detect the input voltage or the output voltage of the voltage regulator circuit unit 100, control formation of the bypass path when the level of the detected voltage is lower than the set voltage, and disable the voltage regulator circuit unit 100. Conversely, the voltage monitoring unit 200 may not control the formation of the bypass path when the level of the detected voltage is equal to the set voltage or more. Therefore, the voltage regulator circuit unit 100 may be maintained in the enable state to provide the output voltage.

For example, the voltage monitoring unit 200 may monitor the output voltage of the voltage regulator circuit unit 100, as shown in FIG. 3. Alternatively, the voltage monitoring unit 200 may monitor the input voltage of the voltage regulator circuit unit 100, as shown in FIG. 4.

In addition, the bypass circuit unit 300 may form the bypass path between an input terminal and an output terminal of the voltage regulator circuit unit 100 depending on the control of the bypass path by the voltage monitoring unit 200, as described with reference to FIGS. 1 and 2.

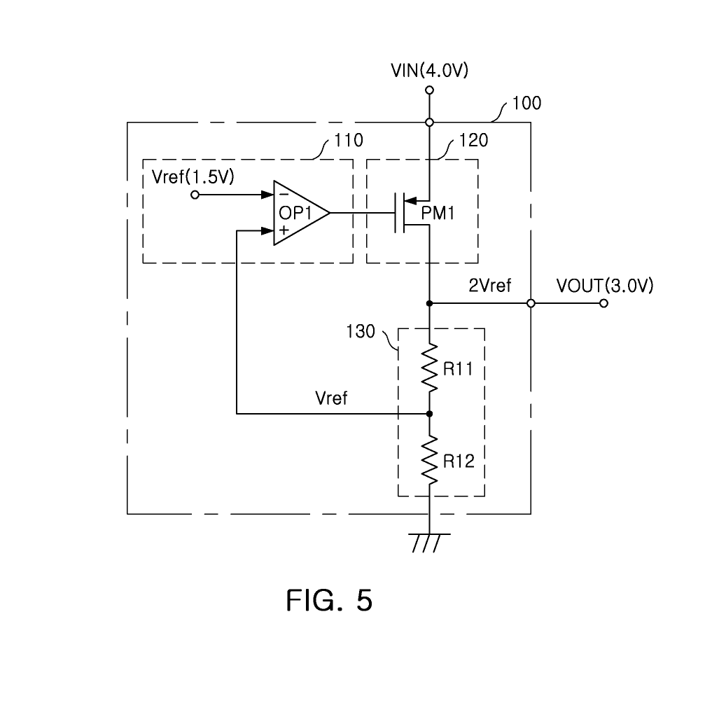

FIG. 5 is a circuit diagram of a voltage regulator circuit unit according to an exemplary embodiment of the present disclosure.

Referring to FIG. 5, the voltage regulator circuit unit 100 may include an error amplifying unit 110, a semiconductor device 120, and a feedback voltage detecting unit 130. In addition, the voltage regulator 100 may further include a reference voltage generating unit generating a reference voltage Vref.

The error amplifying unit 110 may provide a gate signal to the semiconductor device 120 depending on a voltage difference between the reference voltage Vref and a feedback voltage Vfb.

The error amplifying unit 110 may include an operational amplifier OP1, wherein the operational amplifier OP1 may provide a gate signal SG having a level corresponding to a magnitude of a voltage difference between the reference voltage Vref input through an inverting input terminal thereof and the feedback voltage Vfb input through a non-inverting input terminal thereof to the semiconductor device 120.

For example, the operational amplifier OP1 may provide a gate signal SG having a level for switching on the semiconductor device 120 to the semiconductor device 120 when the reference voltage Vref is higher than the feedback voltage Vfb and may provide a gate signal SG having a level for switching off the semiconductor device 120, to the semiconductor device 120, in the case that the level of the reference voltage Vref is not higher than that of the feedback voltage Vfb.

The semiconductor device 120 may adjust a current between the input terminal receiving the input voltage VIN and a ground, depending on the gate signal SG. Here, the semiconductor device 120 may be formed of a switching device such as a transistor. For example, in the case in which the semiconductor device 120 is switched on, a current determined by entire resistance from the input terminal to the ground and the input voltage VIN may flow.

For example, the semiconductor device 120 may include a P-channel metal oxide semiconductor (PMOS) transistor PM1 having a source connected to the input terminal receiving the input voltage VIN, a gate connected to an output terminal of the error amplifying unit 110, and a drain connected to the feedback voltage detecting unit 130. Here, the PMOS transistor PM1 may adjust a source-drain current depending on the gate signal SG.

The feedback voltage detecting unit 130 may be connected between the semiconductor device 120 and the ground to detect the level of the feedback voltage Vfb. The voltage detecting unit 210 may detect the output voltage VOUT using at least one resistor to provide the feedback voltage Vfb.

For example, the voltage detecting unit 210 may include at least two resistors, that is, first and second resistors R21 and R22, connected in series with each other between the output terminal of the voltage regulator circuit unit 100 and the ground, and provide the feedback voltage Vfb from a connection node between the first and second resistors R21 and R22.

Here, the feedback voltage Vfb may be provided from the connection node between the first and second resistors R21 and R22. For example, in the case in which a resistance ratio between the first and second resistors R21 and R22 is 1:1, when the input voltage VIN is 5V and the reference voltage Vref is 0.9V, the feedback voltage Vfb may be 0.9V (=Vref) and the output voltage may be 3V (2Vref).

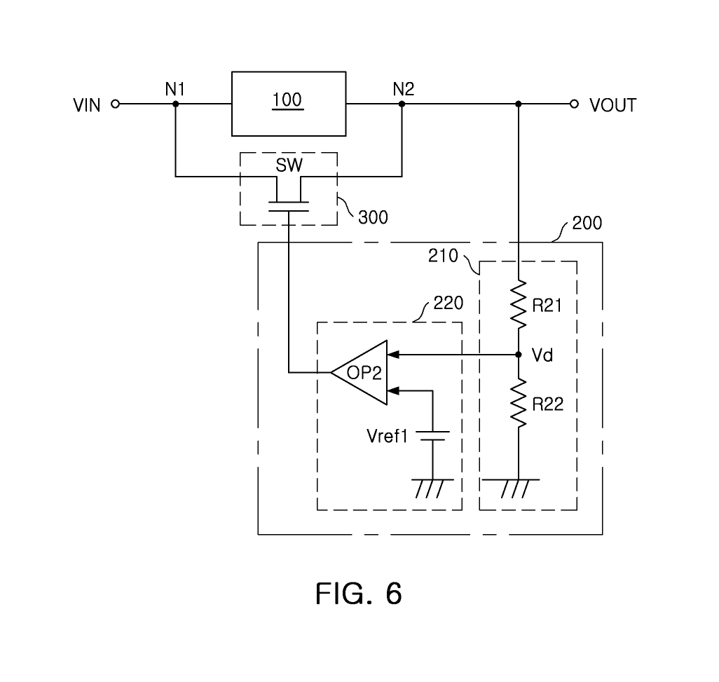

FIG. 6 is a detailed diagram of a voltage monitoring unit and a bypass circuit unit according to an exemplary embodiment of the present disclosure.

Referring to FIG. 6, the voltage monitoring unit 200 may include a voltage detecting unit 210 and a comparing unit 220.

The voltage detecting unit 210 may detect the input voltage or the output voltage of the voltage regulator circuit unit 100 to provide the detected voltage Vd. Although the case in which the voltage detecting unit 210 detects the output voltage of the voltage regulator circuit unit 100 to provide the detected voltage Vd has been shown in FIG. 6, this is only an example, and the present disclosure is not limited thereto.

For example, the voltage detecting unit 210 may include at least two resistors, that is, first and second detection resistors R21 and R22, connected in series with each other between the output terminal of the voltage regulator circuit unit 100 and the ground. The detected voltage Vd may be provided from a connection node between the first and second detection resistors R21 and R22.

Although the case in which the voltage detecting unit 210 detects the output voltage of the voltage regulator circuit unit 100 has been described above, this is only an example, and the present disclosure is not limited thereto.

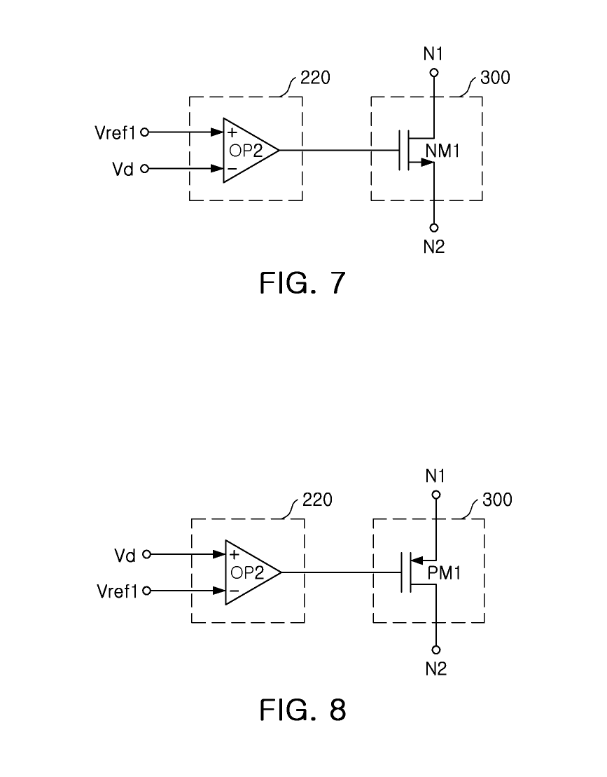

The comparing unit 220 may compare the detected voltage Vd and a set voltage Vref1 with each other and provide a control signal depending on the comparison result to the bypass circuit unit 300. For example, the comparing unit 220 may include an operational amplifier OP2, which will be described with reference to FIGS. 7 and 8.

The bypass circuit unit 300 may include a semiconductor switching device SW connected between the input terminal (input node=N1) and the output terminal (output node=N2) of the voltage regulator circuit unit 100, wherein the semiconductor switching device SW1 may be operated in a switched-on state depending on the control of the bypass path by the voltage monitoring unit 200.

FIG. 7 is a diagram showing an implementation of a comparing unit and a bypass circuit unit according to an exemplary embodiment of the present disclosure; and FIG. 8 is a diagram showing another implementation of a comparing unit and a bypass circuit unit according to an exemplary embodiment of the present disclosure.

Referring to FIG. 7, the comparing unit 220 may include an operational amplifier OP2 having a non-inverting input terminal receiving the set voltage Vref1, an inverting input terminal receiving the detected voltage Vd, and an output terminal comparing the levels of the detected voltage Vd and the set voltage Vref1 with each other and providing the control signal depending on the comparison result.

For example, the operational amplifier OP2 may provide the control signal having a high level when the set voltage Vref1 is higher than the detected voltage Vd and provide the control signal having a low level when the detected voltage Vd is higher than the set voltage Vref1.

Here, the bypass circuit unit 300 may include an N-channel MOS (NMOS) transistor NM1 as a semiconductor switching device SW, wherein the NMOS transistor NM1 may be in a turned-on state in the case in which the control signal from the operational amplifier OP2 has a high level.

Referring to FIG. 8, the comparing unit 220 may include an operational amplifier OP2 having a non-inverting input terminal receiving the detected voltage Vd, an inverting input terminal receiving the set voltage Vref1, and an output terminal comparing the levels of the detected voltage Vd and the set voltage Vref1 with each other and providing the control signal depending on the comparison result.

For example, the operational amplifier OP2 may provide the control signal having a high level when the level of the detected voltage Vd is higher than the level of the set voltage Vref1 and provide the control signal having a low level when the level of the set voltage Vref1 is higher than the detected voltage Vd.

Here, the bypass circuit unit 300 may include a PMOS transistor PM1 as a semiconductor switching device SW, wherein the PMOS transistor PM1 may be in a turned-on state in the case in which the control signal from the operational amplifier OP2 has a low level.

As described above with reference to FIGS. 7 and 8, when the detected voltage Vd is lower than the set voltage Vref1, the bypass circuit unit 300 may be in the turned-on state to provide the bypass path.

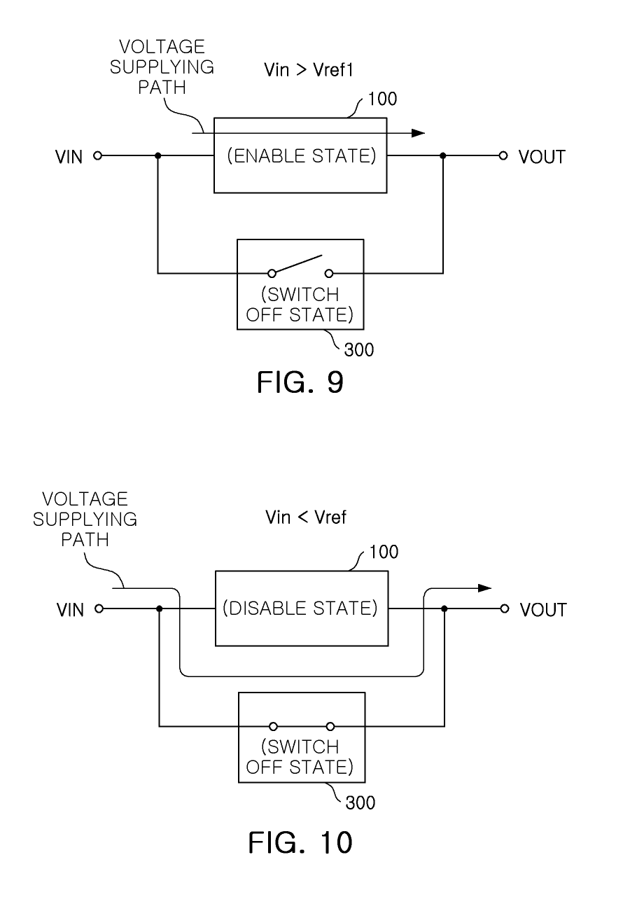

FIG. 9 is a diagram for describing a voltage supplying path by a regulating mode according to an exemplary embodiment of the present disclosure; and FIG. 10 is a diagram for describing a voltage supplying path by a bypass mode according to an exemplary embodiment of the present disclosure.

Describing an operation of a regulating mode with reference to FIG. 9, when the level of the detected voltage Vd is higher than the level of the set voltage Vref1, the bypass circuit unit 300 may be in a turned-off state and the voltage regulator circuit unit 100 may be in an enable state, such that the output voltage may be provided from the voltage regulator circuit unit 100.

Unlike this, describing an operation of a bypass mode with reference to FIG. 10, when the level of the detected voltage Vd is lower than the level of the set voltage Vref1, the bypass circuit unit 300 may be in a turned-on state and the voltage regulator circuit unit 100 may be in a disable state, such that the input voltage may be provided as the output voltage through the bypass circuit unit 300.

As set forth above, according to exemplary embodiments of the present disclosure, even in the case in which the input voltage or the output voltage of the voltage regulator circuit unit drops to the level of the reference voltage or below, the output voltage may be continuously provided using the bypass mode.

While exemplary embodiments have been shown and described above, it will be apparent to those skilled in the art that modifications and variations could be made without departing from the spirit and scope of the present disclosure as defined by the appended claims.

What is claimed is:

1. A voltage regulator comprising:
a voltage regulator circuit unit configured to convert an input voltage into an output voltage;
a voltage monitoring unit configured to detect the level of the input voltage or the output voltage of the voltage regulator circuit unit, compare the levels of the detected voltage and a set voltage with each other, and control a bypass path depending on a comparison result; and
a bypass circuit unit forming the bypass path between an input terminal and an output terminal of the voltage regulator circuit unit depending on a control of the bypass path by the voltage monitoring unit.

2. The voltage regulator of claim 1, wherein the voltage monitoring unit includes:
a voltage detecting unit configured to detect the level of the input voltage or the output voltage of the voltage regulator circuit unit to provide the detected voltage; and
a comparing unit configured to compare the levels of the detected voltage and the set voltage with each other and provide a control signal to the bypass circuit unit depending on the comparison result.

3. The voltage regulator of claim 1, wherein the bypass circuit unit includes a semiconductor switching device connected between the input terminal and the output terminal of the voltage regulator circuit unit,
the semiconductor switching device being operable in a switched-on state depending on the control of the bypass path by the voltage monitoring unit.

4. A voltage regulator comprising:
a voltage regulator circuit unit configured to convert an input voltage into an output voltage;
a voltage monitoring unit configured to detect the level of the input voltage or the output voltage of the voltage regulator circuit unit, compare the levels of the detected voltage and a set voltage with each other, control a bypass path depending on the comparison result, and disabling the voltage regulator circuit unit; and
a bypass circuit unit forming the bypass path between an input terminal and an output terminal of the voltage regulator circuit unit depending on a control of the bypass path by the voltage monitoring unit.

5. The voltage regulator of claim 4, wherein the voltage monitoring unit includes:
a voltage detecting unit configured to detect the level of the input voltage or the output voltage of the voltage regulator circuit unit to provide the detected voltage; and
a comparing unit configured to compare the levels of the detected voltage and the set voltage with each other and provide a control signal to the bypass circuit unit depending on the comparison result.

6. The voltage regulator of claim 4, wherein the bypass circuit unit includes a semiconductor switching device connected between the input terminal and the output terminal of the voltage regulator circuit unit,
the semiconductor switching device being operable in a switched-on state depending on the control of the bypass path by the voltage monitoring unit.

7. A voltage regulator comprising:
a voltage regulator circuit unit configured to provide an output voltage lower than an input voltage;
a voltage monitoring unit configured to detect the level of the input voltage or the output voltage of the voltage regulator circuit unit and control a bypass path when the level of the detected voltage is lower than a set voltage; and
a bypass circuit unit forming the bypass path between an input terminal and an output terminal of the voltage regulator circuit unit depending on the control of the bypass path by the voltage monitoring unit.

8. The voltage regulator of claim 7, wherein the voltage regulator circuit unit includes:
an error amplifying unit configured to provide a gate signal depending on a voltage difference between a reference voltage and a feedback voltage;
a semiconductor device configured to adjust a current between the input terminal receiving the input voltage and a ground depending on the gate signal; and
a feedback voltage detecting unit connected between the semiconductor device and the ground to detect the level of the feedback voltage.

9. The voltage regulator of claim 7, wherein the voltage monitoring unit includes:
a voltage detecting unit configured to detect the level of the input voltage or the output voltage of the voltage regulator circuit unit to provide the detected voltage; and
a comparing unit configured to compare the levels of the detected voltage and the set voltage with each other and providing a control signal to the bypass circuit unit depending on the comparison result.

10. The voltage regulator of claim 9, wherein the voltage detecting unit divides the output voltage using at least one resistor.

11. The voltage regulator of claim 9, wherein the comparing unit includes an operational amplifier having a non-inverting input terminal receiving the set voltage, an inverting input terminal receiving the detected voltage, and an output terminal comparing the levels of the detected voltage and the set voltage with each other and providing the control signal depending on the comparison result.

12. The voltage regulator of claim 9, wherein the comparing unit includes an operational amplifier having a non-inverting input terminal receiving the detected voltage, an inverting input terminal receiving the set voltage, and an output terminal comparing the levels of the detected voltage and the set voltage with each other and providing the control signal depending on the comparison result.

13. The voltage regulator of claim 7, wherein the bypass circuit unit includes a semiconductor switching device connected between the input terminal and the output terminal of the voltage regulator circuit unit,
the semiconductor switching device being operated in a switched-on state depending on the control of the bypass path by the voltage monitoring unit.

14. A voltage regulator comprising:
a voltage regulator circuit unit configured to provide an output voltage lower than an input voltage;
a voltage monitoring unit configured to detect the level of the input voltage or the output voltage of the voltage regulator circuit unit, control a bypass path when the level of the detected voltage is lower than a set voltage, and disable the voltage regulator circuit unit; and
a bypass circuit unit forming the bypass path between an input terminal and an output terminal of the voltage regulator circuit unit depending on the control of the bypass path by the voltage monitoring unit.

15. The voltage regulator of claim 14, wherein the voltage regulator circuit unit includes:
an error amplifying unit configured to provide a gate signal depending on a voltage difference between a reference voltage and a feedback voltage;
a semiconductor device configured to adjust a current between the input terminal receiving the input voltage and a ground depending on the gate signal; and
a feedback voltage detecting unit connected between the semiconductor device and the ground to detect the level of the feedback voltage.

16. The voltage regulator of claim 14, wherein the voltage monitoring unit includes:
a voltage detecting unit configured to detect the level of the input voltage or the output voltage of the voltage regulator circuit unit to provide the detected voltage; and
a comparing unit configured to compare the levels of the detected voltage and the set voltage with each other and provide a control signal to the bypass circuit unit depending on the comparison result.

17. The voltage regulator of claim 16, wherein the voltage detecting unit includes first and second resistors connected in series with each other between the output terminal of the voltage regulator circuit unit and a ground, and
the detected voltage is provided from a connection node between the first and second resistors.

18. The voltage regulator of claim 16, wherein the comparing unit includes an operational amplifier having a non-inverting input terminal receiving the set voltage, an inverting input terminal receiving the detected voltage, and an output terminal comparing the levels of the detected voltage and the set voltage with each other and providing the control signal depending on the comparison result,
the operational amplifier providing the control signal to the bypass circuit unit and the voltage regulator circuit unit, respectively.

19. The voltage regulator of claim 16, wherein the comparing unit includes an operational amplifier having a non-inverting input terminal receiving the detected voltage, an inverting input terminal receiving the set voltage, and an output terminal comparing the levels of the detected voltage and the set voltage with each other and providing the control signal depending on the comparison result,
the operational amplifier configured to provide the control signal to the bypass circuit unit and the voltage regulator circuit unit, respectively.

20. The voltage regulator of claim 14, wherein the bypass circuit unit includes a semiconductor switching device connected between the input terminal and the output terminal of the voltage regulator circuit unit,
the semiconductor switching device being operable in a switched-on state depending on the control of the bypass path by the voltage monitoring unit.
